(19) United States
(12) Patent Application Publication
(10) Pub. No.: US 2006/0155643 A1
(43) Pub. Date: Jul. 13, 2006

(54) Payment instrument notification

(75) Inventors: Andrew W. Shuman, Seattle, WA (US); Ashwin K. Sarin, Redmond, WA (US); Jeffrey D. Carnahan, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/031,522

(22) Filed: Jan. 7, 2005

(51) Int. Cl. G06Q 40/00

(52) U.S. Cl. 705/40

(57) ABSTRACT

Payment instrument notification is described. In an implementation, a method is described in which a user is notified of impending expiration of a payment instrument that is utilized to interact with a service. The notification is performed such that the user is permitted to interact with the service during a period of time between the notification and the expiration.

### TECHNICAL FIELD

The present invention generally relates to notifications and more particularly relates to systems, methods and apparatus payment instrument notification.

### BACKGROUND

Users have access to a wide variety of services. One such example is web-based services (i.e., web services). Web services (also commonly referred to as “application services”) are services that are available over a network for access by users and/or programmatically by other web services. Web services may be utilized to provide a wide variety of functionality, such as for data storage, communication of messages, access to content (e.g., movies, music and television programming), as an information resource (e.g., stock quotes and weather data), and so on. Another example of a service is a local service which is provided locally on the computing device. For example, a set-top box may be configured to include memory which contains a locally stored video-on-demand (VOD). The output of the VOD may be provided through a VOD service which is executed locally on the set-top box.

In some instances, however, a right to interact with the services must be purchased by a user. For example, a user may purchase a subscription to gain access to additional services (e.g., extended content) from a web site by providing information relating to a payment instrument. For instance, the payment instrument may include a variety of credit information for processing a transaction, such as information obtained from a credit card including a type of the credit card, account number, expiration date, billing address, user name as it appears on the credit card, and so on. The web site provider may then utilize this payment instrument information to regularly charge the user for the access to the additional services. However, in some instances, the expiration date of the subscription may extend past an expiration time of the payment instrument, e.g., the expiration date of the credit card.

The expiration of the payment instrument may cause the termination of the user's right to access the service. Therefore, attempts by the user to access the additional services after the expiration date may be blocked by the web site provider. Consequently, the lapse in the payment instrument commonly resulted in telephone calls to support personnel of the web site provider to update the expiration date, which is both inconvenient to the user and costly to the web site provider. Further, because of this inconvenience, the user may chose to stop use of the additional services, which results in lost sales opportunities of the web site provider and loss of the functionality provided by the additional services to the user.

Therefore, there is a continuing need for payment instrument notification, such as notification of impending expiration of a payment instrument.

### SUMMARY

Systems, methods and apparatus for payment instrument notification are described. In an implementation, a method is described in which a user is notified of impending expiration of a payment instrument that is utilized to interact with a service. The notification is performed such that the user is permitted to interact with the service during a period of time between the notification and the expiration. For example, the impending expiration of the payment instrument may be determined from an expiration date of a credit card that is described by the payment instrument. The notification is output for viewing by the user before the expiration of the payment instrument such that the user may continue to interact with the service and update the expiration date before interaction with the service is terminated.

In another implementation, a computer readable medium having computer executable instructions is described. The instructions configure a computer to output a notification for notifying a user of a billing event that may affect the user's interaction with a service. The computer executable instructions further configure the computer to receive an input, such as from the user, which specifies an amount of time, during which, the user is not to receive an additional notification regarding the billing event.

### BRIEF DESCRIPTION OF THE DRAWINGS

FIG. 1 is an illustration of an environment in an exemplary implementation that is operable to employ techniques for notification regarding a payment instrument.

FIG. 2 is an illustration of a system in an exemplary implementation showing a service provider, a client, a billing system, and an authentication system of FIG. 1 in greater detail.

FIG. 3 is a flow diagram depicting a procedure in an exemplary implementation in which payment instrument information is examined and a user is notified of impending expiration of the payment instrument.

FIG. 4 is an illustration of a window in an exemplary implementation that is configured to notify a user of the impending expiration date as determined by the procedure of FIG. 3 and is configured to accept a user input to update the payment instrument information.

FIG. 5 is a flow diagram depicting a procedure in an exemplary implementation in which a notification time for output of a notification of a billing event is reset by a user for later notification.

FIG. 6 is a flow diagram depicting a procedure in an exemplary implementation in which notifications are selected for output based a relative urgency of a corresponding billing event.

FIG. 7 is a flow diagram depicting a procedure in an exemplary implementation in which a billing system exposes a subset of payment instrument information to an authentication system for directing a client to the billing system to update payment instrument information.

The same reference numbers are utilized in instances in the discussion to reference like structures and components.

### DETAILED DESCRIPTION

Overview

Systems, methods and apparatus for payment instrument notification are described. Some services, such as subscription-based web services, require a fee for interaction with the services. Accordingly, providers of such services (i.e., service providers) need information from an “up-to-date” payment instrument of a user (e.g., valid credit card information) to permit user interaction with the services. In some instances, however, delays and even termination of access to the services may be caused by a failure of a user to update the information, such as to provide an updated expiration date of a credit card to the service provider. For example, access to a service may be terminated when a billing system is unable to charge the user, such as when a credit card company declines a transaction due to expiration of information relating to a payment instrument. Accordingly, in an implementation, a system is described which notifies the user that updated information from a payment instrument is needed to prevent termination of the user's interaction with the service. For example, a notification may be output in conjunction with a “login” process for viewing by the user. In this implementation, the notification is output while the user still has access to the service. By notifying the user before the expiration occurs, the user is more likely to update the information to continue interaction with the service, thereby improving the user's experience with the service and preserving the service provider's customer base.

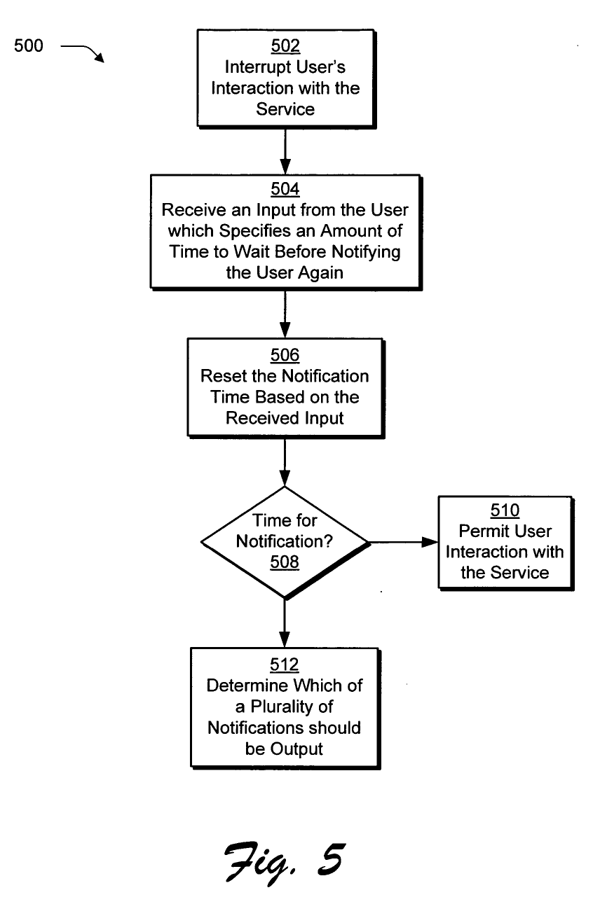

In an additional implementation, the user is provided with a “snooze” feature which enables the user to delay output of the notifications, such as for a selected amount of time. Therefore, the user may delay interruptions caused by the output of notifications until such a time as the user has access to the required information, such as an updated expiration date of a credit card. Further discussion of the “snooze” feature may be found in relation to FIG. 5.

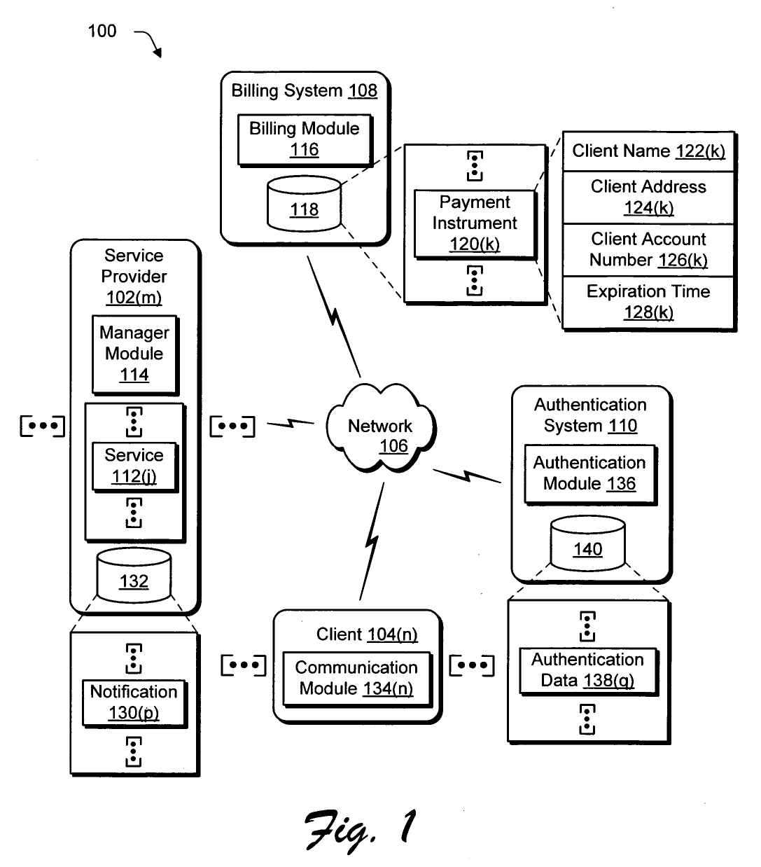

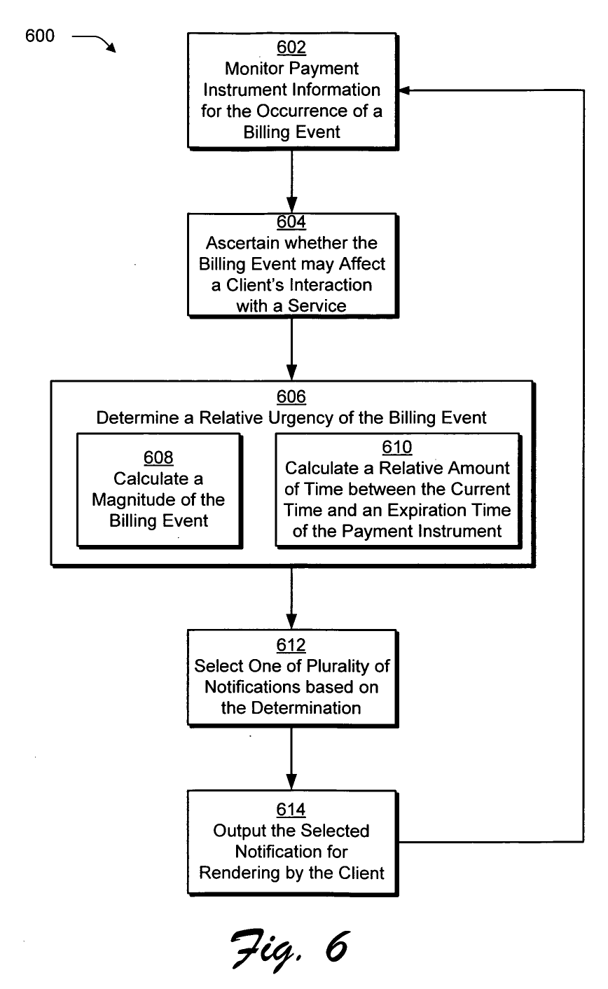

In a further implementation, a hierarchy of notifications is provided for notifying the user of a billing event based on a relative urgency of the billing event. For example, each of the plurality of notifications may be arranged in a hierarchy for output based on a predetermined priority, on “how close” they occur to a next attempt to bill the user, or based on other criteria. For instance, one of the notifications may be configured as a friendly reminder that the expiration date is set to occur within three months, while another one of the notifications may be configured as a warning to the user that the expiration date will occur within a week. A variety of other notification hierarchies may also be employed, such as a hierarchy of notifications based on magnitude, further discussion of which may be found in relation to FIGS. 1 and 6.

Exemplary Environment

FIG. 1 is an illustration of an environment 100 in an exemplary implementation that is operable to employ payment instrument notification techniques. The illustrated environment 100 includes a plurality of service providers 102(m), where “m” can be any integer from one to “M”, and a plurality of clients 104(n), where “n” can be any integer from one to “N”, which are communicatively coupled, one to another, over a network 106. The network 106 is further illustrated as communicatively coupling a billing system 108 and an authentication system 110 such that the service providers 102(m), clients 104(n), billing system 108, and authentication system 110 are communicatively coupled, one to another.

The clients 104(n) may be configured in a variety of ways. For example, the client 104(n) may be configured as a computing device that is capable of communicating over the network 106, such as a desktop computer, a mobile station, an entertainment appliance, a set-top box communicatively coupled to a display device, a wireless phone, a game console, and so forth. Thus, the clients 104(n) may range from full resource devices with substantial memory and processor resources (e.g., personal computers, game consoles) to a low-resource device with limited memory and/or processing resources (e.g., traditional set-top boxes, hand-held game consoles). In the following discussion, the clients 104(n) may also relate to a person and/or entity that operates the respective client. In other words, clients 104(n) may describe logical clients that include users and/or computing devices.

Although the network 106 is illustrated as the Internet, the network 106 may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. For instance, the service provider 102(m) and the billing system 108 may be communicatively coupled, one to another, via a corporate Intranet. Additionally, both the service provider 102(m) and the billing system 108 may be communicatively coupled to the clients 104(n) and the authentication system 110 over the Internet. A wide variety of other instances are also contemplated.

The service provider 102(m) includes a plurality of services 112(j), where “j” can be any integer from one to “J”. In the illustrated environment 100, the services 112(j) are configured as web services which are accessible by the plurality of clients 104(n) over the network 106. As previously described, web services may be utilized to provide a wide variety of functionality, such as for data storage, communication of messages, access to content (e.g., movies, music and television programming), as an information resource (e.g., stock quotes and weather data), and so on. Although the following discussion will describe the services 112(j) as web services, the services may be configured in a wide variety of other ways, such as services which are local to the client 104(n) (e.g., for viewing locally stored content).

In the illustrated environment 100, the service provider 102(m) includes a manager module 114 to manage the plurality of services 112(j). For example, the manager module 114 may be executed to receive requests from the plurality of clients 104(n), locate a corresponding one of the plurality of services 112(j) for processing the request, direct the client 104(n) to provide payment instrument information and permit access to services 112(j) which require such information, and so on.

The service provider 102(m), for instance, may provide a subscription-based service 112(j) for access by the client 104(n) over the network 106. The subscription-based service 112(j) may require recurring payments by the client 104(n) for access to the service 112(j). For example, a service may require a daily, weekly, monthly or yearly fee for access to the service. Subscription based services may also be configured to address usage-based services. For example, a subscription may include a recurrent fee of zero and a usage fee which is charged for each download of content via the service, charged for each time the client accesses the service, and so on.

To process transactions that permit the client 104(n) to interact with the service 112(j), the service provider 102(m) may communicate with the billing system 108. The billing system 110 includes a billing module 116 which is executable to process transactions that occur between the service provider 102(m) and the client 104(n). For example, the billing module 116 may access a database 118 having information which describes a plurality of payment instruments 120(k), where “k” can be any integer from one to “K”. Each payment instrument 120(k) may be configured and arranged in a variety of ways, such as divided into individual sets which correspond to particular clients, e.g., client accounts. For example, payment instrument 120(k) may include data which relates to a particular client 104(n), such as a client name 122(k), a client address 124(k) (e.g., a billing address), a client account number 126(k) (e.g., a credit card account number, a bank account number, and so on), an expiration time 128(k) of the client account number 126(k) (e.g., an expiration date of a credit card), and so on. While credit card information is discussed in instances in the following discussion for the sake of clarity and brevity, payment instruments may be configured in a variety of ways, such as prepayment instruments, wholesale arrangements, contractual arrangements, and so on.

The billing module 116 is also executable to inform the manager module 114 of a result of the processing, such as successful transfer of funds, insufficient funds, expiration of the payment instrument 120(k), and so on. Thus, the billing module 116 may inform the manager module 114 of billing events that may affect a determination made by the manager module 114 of whether to permit access by the client 104(n) to the services 112(j).

Upon receipt of a result of the processing, for instance, the manager module 114 may then determine whether to permit access by the client 104(n) to the services 112(j) based on a wide variety of considerations. For example, the manager module 114 may receive a result that indicates that the client 104(n) has a valid payment instrument 120(k) (e.g., a bank account with sufficient funds) and therefore permit access to the service 112(j). On the other hand, the manager module 114 may restrict access if the payment instrument 120(k) is not valid, such as due to insufficient funds. In a further example, even though the payment instrument 120(k) is not valid, the manager module 114 may still permit access to the service 112(j). For instance, the expiration time 128(k) of the payment instrument 120(k) may have been exceeded. However, the manager module 114 may determine that access to the service 112(j) by the client 104(n) is still permitted for a probationary period of time to give the client 104(n) a chance to update the expiration time 128(k), such as an expiration date of a credit card. In another instance, a daily withdrawal limit may have been reached. Therefore, the manager module 114 may permit access to the service 112(j) for another day until the transaction can be completed.

In yet another example, the manager module 114, through communication with the billing module 116, may determine in advance that the expiration time 128(k) is impending, i.e., will occur in the future. Before the expiration time is reached, the manager module 114 may communicate one or more of a plurality of notifications 130(p), where “p” can be any integer from one to “P”, from a database 132 over the network 106 to the client 104(n). Thus, the client 104(n) may be notified “ahead of time” such that the client 104(n) still has access to the service 112(j). In this way, the notification 130(p) may serve as a reminder that continued interaction with the service 112(j) in the future will require an update to the payment instrument 120(k) information, and that immediate update of the payment instrument information is requested but not required.

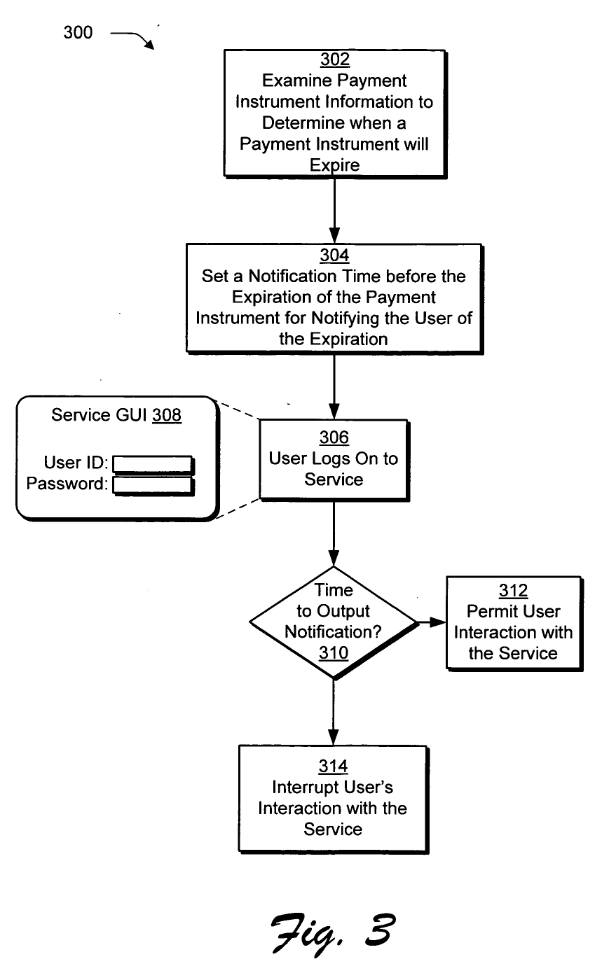

It should be noted that in an implementation, the expiration of payment instruments 120(k) is not limited to payment instrument 120(k) obtained directly from the client 104(n). For example, the client 104(n) may receive an offer for “one-month free trial” of the service 112(j). After expiration of this free month, another valid payment instrument is required from the client 104(n) to continue interaction with the service 112(j). Therefore, rather than wait until the one-free month has expired, the manager module 114 may select a notification 130(p) from the database 132 and communicate the notification to the client 104(n) before the expiration of the free trial period. By providing this notification before the expiration of the trial period, the client 104(n) is more likely to enter information from another payment instrument 120(k), such as a credit card. Further discussion of client notification may be found beginning in relation to FIG. 3.

A variety of techniques may be employed by the manager module 114 to select one or more of the plurality of notifications 130(p) for communication to and output by the client 104(n). For example, the manager module 114 may select a notification 130(p) based on a relative urgency of a billing event which prompts the output of a notification. For instance, an “insufficient funds” billing event may be utilized to select a notification for warning the client 104(n) that access to the service 112(j) is no longer permitted until valid payment instrument 120(k) information (e.g., sufficient payment instrument information and funds to complete a transaction) has been obtained from the client 104(n). In another instance, an “expired payment instrument” billing event may be utilized to select a notification which requests that the client 104(n) update the payment instrument 120(k), but may still allow the client 104(n) to interact with the service 112(j) for a period of time, such as due to a significant history of on-time payments from that client 104(n). Thus, in these instances the magnitude of the effect of the billing event on the client's 104(n) interaction with the service 112(j) (e.g., termination of access vs. continued probationary access) may be utilized to select a corresponding notification 130(p).

In another example, the manager module 114 may select a notification 130(p) based on an amount of time that remains between the current time and the expiration time 128(k). For instance, the plurality of notifications 130(p) may be arranged in a hierarchy based on how much time remains between the current time and the expiration time 128(k). The manager module 114 may then select one or more of the notifications 130(p) which correspond to the amount of time for output to the client 104(n). Further discussion of selection of notifications 130(p) may be found in relation to FIG. 6.

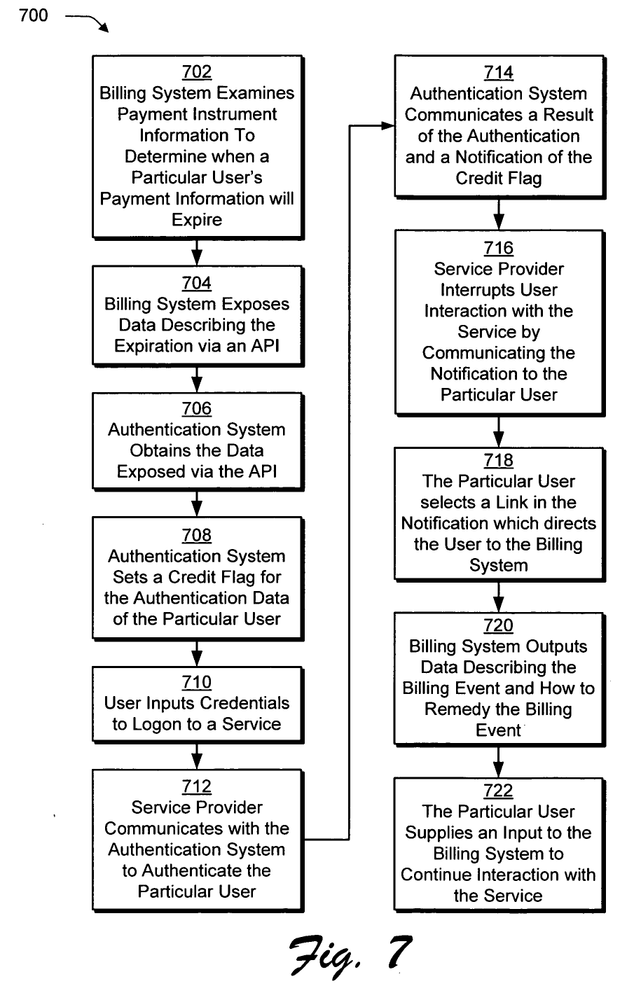

In some instances, the services 112(j) may limit access to certain clients 104(n), such as content subscribers, group members, and so on. Accordingly, an authentication system 110 may be utilized to authenticate the client 104(n) for interaction with the services 112(j) of the service provider 102(m). For example, the client 104(n) may execute a communication module 134(n) (e.g., a web browser) to access the service 112(j) over the network 106. The service 112(j), in this example however, may require that the client 104(n) “logon” to the service provider. Therefore, the manager module 114 may direct the client 104(n) to an authentication system 110. The authentication system 110 includes an authentication module 136 which is executable to compare credentials obtained from the client 104(n) (e.g., user ID and password) with a corresponding set of a plurality of authentication data 138(q), where “q” can be any integer from one to “Q”, stored in a database 140. A result of the authentication is communicated from the authentication module 136 to the manager module 114, which may be utilized by the manager module 114 to determine whether interaction with the service 112(j) by the client 104(n) is permitted. Further discussion of the authentication system 110 may be found in relation to FIG. 7.

Although the service provider 102(m), billing system 108 and the authentication system 110 are illustrated in FIG. 1 as being implemented via a plurality of stand-alone modules, these components of environment 100 may be combined and/or further divided in a variety of ways. For example, in another implementation, the service provider 102(m) may include the billing system 108 and access the authentication system 110 via the network 106.

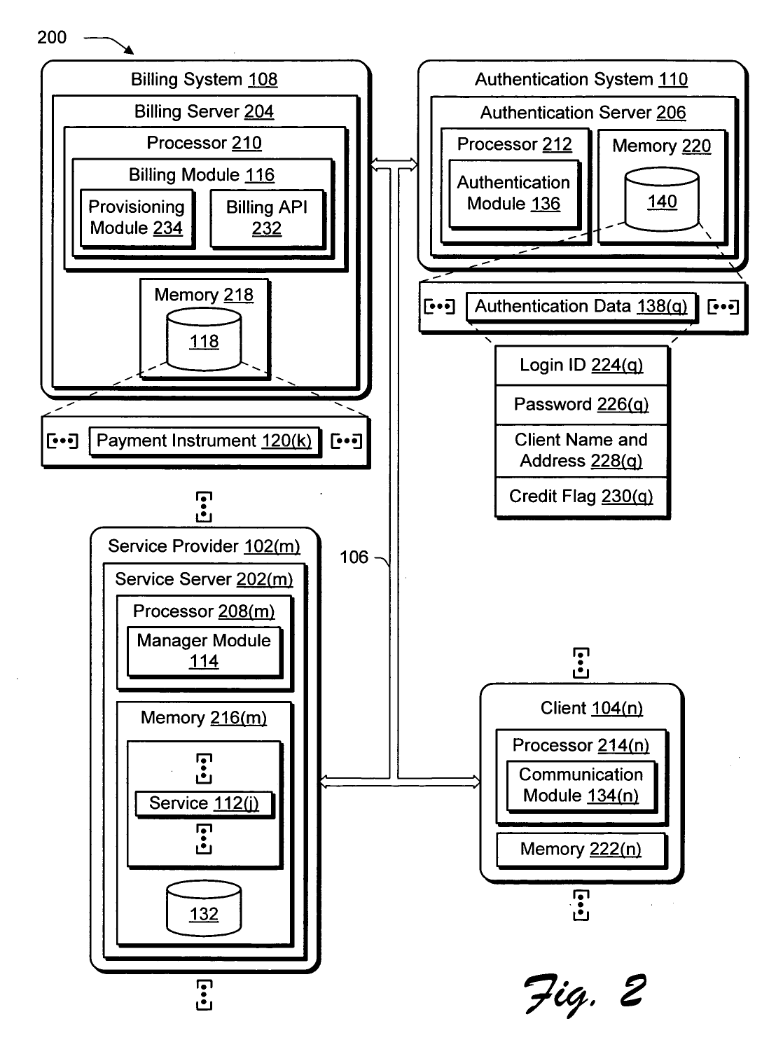

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the notification techniques described below are platform-independent, meaning that the techniques may be implemented on a variety of commercial computing platforms having a variety of processors.

FIG. 2 is an illustration of a system 200 in an exemplary implementation showing the service provider 102(m), the client 104(n), the billing system 108, and the authentication system 110 of FIG. 1 in greater detail. The service provider 102(m) is illustrated as including a service server 202(m), the billing system 108 is illustrated as including a billing server 204, the authentication system 110 is illustrated as including an authentication server 206, and the client 104(n) is illustrated as a client device. The service server 202(m), billing server 204, authentication server 206, and the client 104(n) device each include a respective processor 208(m), 210, 212, 214(n) and a respective memory 216(m), 218, 220, 222(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 216(m), 218, 220, 222(n) is shown, respectively, for the service server 202, the billing server 204, the authentication server 206, and the client 104(n), a wide variety of types and combinations of memory may be employed, such as random access memory (RAM), hard disk memory, removable medium memory, and so forth. For example, the services 112(j) of the service server 202(m) may be stored in RAM and the database 132 may be implemented by a hard disk drive.

As previously described, one or more of the plurality of services 112(j) may require that a user “logon” to the service. For instance, the service may provide client specific information, such as email, instant messages, a personalized web page, and so on. The logon process may be accomplished in a variety of ways. For instance, the service 112(j) itself may request a client 104(n) (e.g., user) identifier (ID) and a password. In another instance, the service 112(j) may utilize a dedicated authentication system 110. For example, the authentication data 138(q) may be arranged into a plurality of client accounts for verifying the client 104(n). One such example of an authentication system is the MICROSOFT PASSPORT system (MICROSOFT and PASSPORT are both trademarks of the Microsoft Corporation, Redmond, Wash.). The authentication system 110, for instance, may be configured to provide a “single login” system such that service providers 102(m) that “participate” with the authentication system 110 may transfer account management. Thus, the authentication system 110 may act as a shared and specialized authentication service that maintains a centralized list of accounts (e.g., sets of the authentication data 138(q)) for use by the plurality of service providers 102(m). For example, when a service 112(j) that participates with the authentication system 110 desires to authenticate the client 104(n), the service 112(j) (either by itself and/or through the manager module 114) delegates this task to the authentication system 110. The authentication system 110 may then provide a response regarding the authentication of the client 104(n). Thus, the service provider 102(m) only needs to “understand” the response, and does not need to process the authentication itself. Further, the client 104(n) may utilize a single login ID 224(q) and password 226(q) for interacting with the plurality of service providers 102(m).

The authentication data 138(q), for instance, may include a login ID 224(q), a password 226(q), a client name and address 228(q), and a credit flag 230(q). The credit flag 230(q) may be utilized to notify the user when the authentication system 110 is employed that a billing event has occurred in relation to the billing system 108. For example, the authentication system 110 may be utilized for services that require valid payment instrument 120(k), as well as services that do not require payment instrument information, but rather utilize the authentication system 110 to verify a user to provide specific content. Therefore, the billing module 116 may publish a subset of information from the payment instrument 120(k) to the authentication system 110. Upon receipt of the published subset of the information, the authentication module 136 may set the credit flag 230(q) such that the user is notified during login that a billing event has occurred, such as expiration of payment instruments 120(k), insufficient funds, and so on. The billing module 116 may publish the subset of information in a variety of ways. For example, the billing module 116 may provide a billing application programming interface (API) 232 that is accessible by a variety of differing computing platforms, including platforms that are incompatible, one with another. The billing API 232 may “hide” the details of processing the payment instrument 120(k) and may limit the access of outside systems (e.g., the authentication system 110) to the payment instrument 120(k). For example, the payment instrument information available via the billing API 232 may indicate that a billing event has occurred for a particular client 104(n), but does not provide any more details regarding the billing event, the particular client 104(n), and the particular client's 104(n) payment instrument 120(k) such as client account number 126(k), and so on.

The billing module 116 is also illustrated as include a provisioning module 234. The provisioning module 234, when executed, is configured to communicate with the manager module 114 to control which of the plurality of services 112(j) the client 104(n) may access according to the payment instrument 120(k). For example, the payment instrument 120(k) for the client 104(n) may have expired. Accordingly, the provisioning module 234 may form and communicate a message to the manager module 114 which indicates that the payment instrument 120(k) is no longer valid for processing transactions. Therefore, the manager module 114 may limit access to the client 104(n) to services which do not require payment. As previously described, although the manager module 114 and the billing module 116 (and consequently the provisioning module 234) are illustrated as implemented via separate computing devices, i.e., the service server 202(m) and the billing server 204, respectively, the manager module 114 and the billing module 116 may be combined. For instance, the service provider 102(m) may also incorporate the functionality of the billing module 116 to process transactions between the client 104(n) and the service provider 102(m). In another instance, the service provider 102(m) incorporates the functionality of the billing module 116 and the authentication module 136.

Exemplary Procedures

The following discussion describes notification techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 is a flow diagram depicting a procedure 300 in an exemplary implementation in which payment instrument information is examined and a user is notified of an impending expiration of the payment instrument. First, payment instrument information is examined to determine when the payment instrument will expire (block 302). For example, the payment instrument information may describe a credit card, an expiration date of the credit card, a user name as it appears on the credit card, the user's billing address, and so on. Therefore, in this example, the payment instrument is no longer valid (e.g., will expire) in this instance when the expiration date has been exceeded.

Based on the examination, a notification time is set before the expiration of the payment instrument for notifying the user of the expiration (block 304). For example, the notification time may be computed based on an amount of time before the expiration date that the client should be notified. The amount of time may be computed in a variety of ways. For instance, the amount of time may have a set value, such as sixty days before the expiration date of date of a credit card. The amount of time may also be based on a subscription, such as ⅙^{th} of the total time of a content subscription. In this instance, a one-year subscription results in a notification that is set two months before the expiration of the subscription. In another instance, the amount of time may be based on the amount of time that remains until the expiration date is reached. In this instance, a relative amount of time may be set (e.g., fifty percent) such that if one year remains until the expiration date is reached, the notification time is set for six months before the expiration. A variety of other techniques may also be employed for computing the notification time.

A user then initiates a login process to the service (block 306). For example, the service may provide a graphical user interface (GUI) 308 which includes text entry boxes for a user ID and a password. During the login process, such as after the user enters the user ID and password but before the user is permitted to interact with the service, a determination is made as to whether it is time to output the notification (block 310). If the time has not been reached (e.g., the current time does not exceed the notification time), user interaction with the service is permitted (block 312). When the time has been reached, however, the user's interaction with the service is interrupted (block 314). The user's interaction with the service may be interrupted in a variety of ways, such as through output of an audio message which notifies the user of the impending expiration, and/or a visual output of a window, an example of which is shown in the following figure.

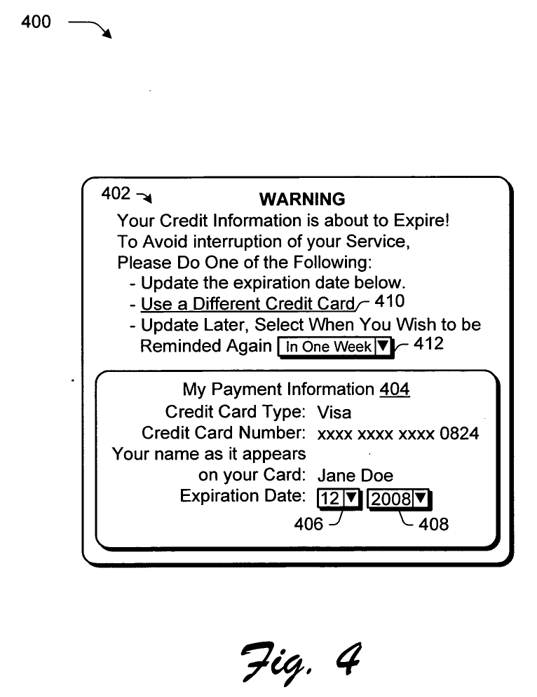

FIG. 4 is an illustration of a window 400 in an exemplary implementation that is configured to notify a user of an impending expiration date and is configured to accept a user input to update the expiration date. The window 400 is configured for output in conjunction with the login process to interrupt the user's interaction to the service to notify the user of a billing event that may affect the user's interaction with the service in the future. The billing event in this implementation is an impending expiration of credit card information.

The window includes a textual message 402 which describes the billing event which triggered the warning, which is illustrated as follows:
Warning, your credit information is about to expire! To avoid interruption of your service, please do one of the following:
   The textual message 402 is then followed by a description of actions that may be performed in response to the billing event. For example, the user is directed to update the expiration date below using the “My Payment Instrument” window 404. The window 404 in this instance describes credit card information, such as credit card type, credit card number and name as it appears on the credit card. The window 404 also includes drop-down menus 406, 408 which may be utilized to update, respectively, a month and year of the expiration date of the credit card. Thus, in this instance, the user is provided with a notification of the billing event (e.g., the impending expiration of the payment instrument) and an action that may be performed through interaction with the window 400 to resolve the billing event, e.g., the drop-down menus 406, 408.

The window 400 also includes a hyperlink 410 which directs the user to another window to enter information describing a different credit card. For example, the user may wish to utilize a new credit card rather than continue use of an old credit card until it expires. Therefore, the user may utilize this opportunity to add the information regarding the different credit card to the payment instrument information.

In some instances, however, the user may be unable or unwilling to perform an action that will resolve the billing event. For example, the user may not have received an updated credit card, and therefore does not have an updated expiration date to enter. In another example, the user may be busy and not want to take the time to enter the expiration date. Therefore, the window 400 may incorporate a “snooze” feature which allows the user to access the service and be reminded by the notification at a later time. The window 400 is illustrated as including a drop-down menu 412 which is configured to allow the user to select an amount of time, during which, the user is not to receive another notification of the billing event. Therefore, when the user logs on to the service during the selected time period, the user's interaction with the service is not interrupted. Further discussion of the snooze feature may be found in relation to the following figure.

FIG. 5 is a flow diagram depicting a procedure 500 in an exemplary implementation in which a notification time for output of a notification of a billing event is reset by a user for later notification. Continuing with the previous example of FIG. 4, a user's interaction with the service is interrupted to output a notification of a billing event (block 502). An input is then received from the user which specifies an amount of time to wait before notifying the user again (block 504). For example, the user may select a representation of a time from the drop down menu 412 of FIG. 4 to select an amount of time. In another example, the user may input text which describes an amount of time, such as “one day” and so on.

Although specification of a particular amount of time has been described, the amount may also be described in a variety of other ways. The user, for example, may select a button that states “remind me later” but does not describe an amount of time. However, selection of the “remind me later” button may automatically cause selection of a predetermined amount of time, such as an amount of time that is predetermined by the service provider. In a further example, the amount of time is dynamic. For example, the “remind me later” button may be based on a number of times the user logs in to a service (e.g., after three logins). A variety of other techniques may also be utilized to specify an amount of time.

The notification time is then reset based on the received input (block 506). For example, the received input of “one week later” may be utilized to add seven days to the notification time. A determination is then made as to whether the time set of notification has been reached (decision block 508). The determination may be performed in a variety of different ways. For example, the determination may be made each time the user logs on to the service. In another example, the determination may be performed at periodic intervals. For instance, a user may logon to a service and remain logged on for an extended period of time, such as due to failure of the user to log off the service. Accordingly, periodic determinations may be utilized to provide a notification to the user even if the user remains “logged on” to the service.

If the notification time has not been reached (decision block 508), user interaction with the service is still permitted (block 510) without interruption. However, when the notification time has been reached (decision block 508), a determination is made as to which of a plurality of notifications should be output (block 512). A variety of considerations may be utilized to select the notification, further discussion of which may be found in relation to the following figure.

FIG. 6 is a flow diagram depicting a procedure 600 in an exemplary implementation in which notifications are selected for output to a user based on a relative urgency of a corresponding billing event. Payment instrument information is monitored to detect an occurrence of a billing event (block 602). For example, the billing module 116 of FIG. 1 may monitor the payment instrument 120(k) to determine if an expiration time 128(k) has been reached, whether sufficient funds are available for continued purchases, and so on. The billing module 116 may then ascertain whether the billing event may affect a client's interaction with a service (block 604).

A determination is then made as to a relative urgency of the billing event (block 606). For example, the billing module may calculate a magnitude of the effect of the billing event on the user's interaction with the service (block 608). For instance, a client's credit card may have a daily withdrawal limit. Therefore, as previously described, the billing module 116 may be configured to allow the client to access the service for another day until another attempt may be made to process the transaction. If a second attempt at processing the transaction fails, however, the billing module may then be configured to terminate access to the service. Thus, in this instance, the effect on the user's interaction with the service is not immediate, but may have an effect in the future. One the other hand, the client may have exceeded a total withdrawal limit, which may be deemed “more serious” and therefore have a greater magnitude. These magnitudes may be determined in a variety of different ways. For example, a billing system 108 may include a table that describes a billing event and an assigned magnitude for the corresponding billing event. Therefore, the billing module 116 may utilize the billing event as an index in the table to determine the relative magnitude, with multiple billing events being combined to achieve a combined magnitude which reflects a relatively greater urgency caused by the combination.

In another example, a relative amount of time may be calculated, for example, between a current time and an expiration time of the payment instrument (block 610). In this example, a determination is made as to “how close” the expiration time is to the current time. Thus, the amount of time may also act as a “magnitude of relative urgency” of the billing event (e.g., the expiration time) that may affect the client's interaction with the service. A variety of other techniques may also be employed for determining a relative urgency of the billing event without departing from the spirit and scope thereof. For example, a calculation may be made as to which billing event has the highest priority by examining the dates that the event is predicted to cause a negative billing impact. The earliest predicted event is then given priority. For instance, if a credit card expires next month, but yesterday the credit card was declined for some other reason, the reason for the decline will be given priority because of its current billing impact.

One of a plurality of notifications is then selected based on the determination (block 612). As previously described, for instance, the plurality of notifications may be arranged in a hierarchy based on “how close” the current time is to the expiration time of payment instrument, i.e., how much time remains until the expiration time. Likewise, the magnitude of the billing event may also be utilized, with “higher” magnitudes having a greater potential effect on the client's interaction with the service being utilized to select a notification which reflects the corresponding relative urgency. For instance, if the magnitude of the billing event is such that access to the service is to be immediately terminated, a warning notification may be selected. In another instance, if the magnitude of the billing event is such that access to the service will continue for a probationary period, a notification is selected which describes that continued access will be permitted for a limited time. The selected notification is then output for rendering by the client (block 614), such as communicated by the service provider 102(m) of FIG. 1 for communication of the network 106 for display on a display device of the client 104(n).

As shown in FIG. 6, the procedure 600 may continue such that successive notifications are output that reflect increased urgency for notification of the client. For example, the expiration date may become increasingly closer each time the client logs on to the service. Thus, with each successive client logon to the service, the relative urgency increases, and therefore notification may be selected which reflect this increased urgency. For instance, a first time a user logs on to a service, the expiration date of a credit card used by the client to pay for access to the service may be a year away. Therefore, a reminder notification may be output to inform the client that indicates a low relative urgency. However, the second time the user logs on to the service, the expiration date of the credit card may be one month away. Therefore, a warning notification may be selected which reflects the relatively “greater” urgency of the billing event, such as by containing language which describes the impending expiration date, a description on how to “cure” (i.e., update) the expiration date, and so on. This procedure 600 may continue even past the expiration date, such as to inform the client that access is limited to update of the expiration date.

FIG. 7 is a flow diagram depicting a procedure 700 in an exemplary implementation in which a billing system exposes a subset of payment instrument information to an authentication system for directing a client to the billing system to update payment instrument information. First, a billing system examines payment instrument information to determine when a particular user's payment instrument will expire (block 702). For example, the billing module 116 of FIG. 1 may be executed to examine each expiration time 128(k) for each set of payment instruments 120(k). Based on the examination, the billing system exposes a subset of the payment instrument information that describes the expiration via an API (block 704). For example, rather than permit access to the entirety of the payment instrument 120(k) for a client (e.g., client account numbers 126(k), expiration times 128(k), and so on), the billing module 116 may expose data which references the impending expiration time 128(k), but does not describe the actual expiration time. Thus, the expiration time 128(k) and the other payment instrument 120(k) information are protected from malicious parties. An authentication system then obtains the data exposed via the API (block 706) and sets a credit flag 230(q) for the authentication data 138(q) of the particular user (block 708).

Therefore, when a user (e.g., client 104(n)) inputs credentials (e.g., login ID 224(q) and password 226(q)) to logon to a service (block 710), the service provider communicates with the authentication system to authenticate the particular user (block 712). The authentication system, upon verifying the user's (e.g., client 104(n)) credentials, may note that the credit flag 230(q) has been set to indicate that a billing event has occurred. The authentication system then communicates a result of the authentication and a notification which describes that the credit flag (block 714) has been set, i.e., the billing event has occurred. It should be noted that in this instance, the notification describes the existence of the billing event, but does not describe the actual billing event to protect the client's payment instrument information.

Upon receipt of the result, the service provider interrupts user interaction with the service by communicating the notification to the particular user (block 716). For example, a window may be output during a login process which directs the user to the billing system. The window may contain a link that, when selected by the user, directs the user to the billing system (block 718).

The billing system may then output data which describes the billing event and how to remedy the billing event (block 720). For example, the billing system may output the window 400 of FIG. 4 for entry of an updated expiration date for a credit card. In response thereto, the particular user may supply an input to the billing system (e.g., selection of dates from the drop-down menus 406, 408 of FIG. 4) to continue interaction with the service (block 722). Thus, in this procedure 700, the account specific payment instrument 120(k) (e.g., account number, expiration date, address, and so on) remains confined to the billing system 108, yet a subset of this information (e.g., a flag indicating an occurrence of a billing event) is utilized to direct the user to the billing system to “remedy” the billing event. Although publishing of the subset was described to an authentication system, the subset may be published to a wide variety of other systems without departing from the spirit and scope thereof. For example, the manager module 114 may also be configured to obtain the subset through the billing API 232 of FIG. 2, such as when the service provider 102(m) is configured to authenticate the client 104(n).

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
notifying a user of an impending expiration of a payment instrument that is utilized to interact with a service; and
permitting the user to interact with the service during a period of time between the notifying and the expiration.

2. A method as described in claim 1, wherein the impending expiration is determined from an expiration date of the payment instrument.

3. A method as described in claim 1, wherein the impending expiration is such that after the expiration, the payment instrument is no longer valid for billing purposes.

4. A method as described in claim 1, wherein the notifying is performed in conjunction with a user login process to the service.

5. A method as described in claim 1, wherein the notifying includes outputting a notification that is configured to receive an input for updating an expiration date referenced by the payment instrument.

6. A method as described in claim 5, wherein the outputting is performed such that access to the service may continue even if the expiration date is not updated.

7. A method as described in claim 1, wherein the notifying includes:
determining a relative urgency, at which, a user is to be notified of the impending expiration; and
selecting one of a plurality of notifications, based on the determining, for notifying the user of the impending expiration.

8. A method as described in claim 7, wherein the relative urgency is determined based upon an amount of time between a current time and an expiration date referenced by the payment instrument.

9. A method as described in claim 1, wherein the payment instrument is selected from the group consisting of:
a credit card;
a debit card;
a free trial; and
a prepaid card.

10. A method comprising:
determining a relative urgency, at which, a user is to be notified of a billing event that may affect the user's interaction with a service; and
selecting one of a plurality of notifications, based on the determining, for notifying the user of the billing event.

11. A method as described in claim 10, wherein:
the relative urgency is determined based upon an amount of time between a current time and an expiration date of credit card information referenced by the payment instrument; and
the plurality of notifications are arranged in a hierarchy such that each said notification is for output, respectively, at differing said amounts of time.

12. A method as described in claim 10, wherein the relative urgency is determined by predicting which a plurality of billing events will affect the user's interaction with the service.

13. A method as described in claim 10, wherein:
the relative urgency is determined based upon a magnitude of the effect on the user's interaction with the service; and
the plurality of notifications are arranged in a hierarchy such that each said notification is for output, respectively, at differing said magnitudes.

14. A method as described in claim 10, wherein the service is a web service.

15. A method as described in claim 10, wherein the service is a subscription-based service.

16. A method as described in claim 10, further comprising:
outputting the selected notification, wherein the selected notification describes an impending expiration of payment instrument information utilized to purchase rights to interact with the service by the user; and
permitting the user to access the service during a period of time between the outputting and the expiration.

17. One or more computer readable media comprising computer executable instructions that, when executed, direct a computer to:
output a notification for notifying a user of a billing event that may affect the user's interaction with a service; and
receive an input which specifies an amount of time, during which, the user is not to receive an additional notification regarding the billing event.

18. One or more computer readable media as described in claim 17, wherein the billing event is an impending expiration of a payment instrument which is utilized by the user to interact with the service.

19. One or more computer readable media as described in claim 17, further comprising outputting another notification for notifying the user of another billing event that may affect the user's interaction with the service during the amount of time.

20. One or more computer readable media as described in claim 17, wherein the computer executable instructions further direct the computer to:
determine a relative urgency, at which, the user is to be notified of the billing event; and
select the notification from a plurality of notifications, based on the determination, for notifying the user of the billing event.
